(19) United States
(12) Patent Application Publication
(10) Pub. No.: US 2008/0235078 A1
(43) Pub. Date: Sep. 25, 2008

(54) SYSTEM AND METHOD FOR TARGET ADVERTISING

(76) Inventors: James HONG, San Francisco, CA (US); Vu Nguyen, Corona, CA (US)

Correspondence Address: MANATT PHELPS AND PHILLIPS;ROBERT D. BECKER, 1001 PAGE MILL ROAD, BUILDING 2, PALO ALTO, CA, 94304, US

(21) Appl. No.: 12/053,495

(22) Filed: Mar. 21, 2008

Related U.S. Application Data
(60) Provisional application No. 60/907,164, filed on Mar. 21, 2007.

(51) Int. Cl. G06Q 30/00

(52) U.S. Cl. 705/10; 705/14

(57) ABSTRACT

A computer-based system and method are described to provide advertisers with effective target advertising. More specifically, the system and method enable individuals to explicitly specify which brands they feel an affinity for in order to determine and present advertisements based on the individual's actual self-described affinities.

### FIELD OF THE INVENTION

The present invention describes a computer-based system and method that explicitly asks individuals to specify which brands they feel an affinity for in order to determine which advertisements would be most effectively displayed to them. In one implementation, the present invention relates to an advertising system informed by user's actual self-described affinities.

### BACKGROUND OF THE INVENTION

Most advertising targeting systems implemented today base their selection of advertisement to be displayed in the context of what a user is searching for or consuming. For example, Google might choose to show an advertisement for “Dell Computers” when a user is on Google's search engine website using the search term “computer”. Another example is that Google might choose to show an advertisement for BMW when showing an advertisement on a page about cars, whether that page is displayed on a page generated by Google or by a third-party using Google AdSense. Google's AdSense system is a contextual advertising solution, matching advertisements to a web publisher's site to deliver advertisements to visitors relevant to the visitor's interests and the site content. (Google AdSense is further described at: http://www.google.com/services/adsense_tour/index.html).

In other systems, marketing firms can attach cookies to track a user's interests. For example, marketing firms can track visits and web surfing habits using cookies. A cookie can be placed on a client computer when a user visits a website or clicks on an advertisement. The cookie is tracked by an advertisement serving log supported by a marketing or advertising firm, and the web surfing history can be added to a database of information revealing the user's interests. When the user visits a website represented by a marketing firm, the advertisement server will recognize the exposed cookie and display an advertisement specifically targeted to the user's interest. The above-described computer software tools, techniques and computer hardware are well known within the art and are typically implemented in web advertisement tracking and targeting.

These techniques are effective at targeting advertisements to some users, but not all. The techniques used to determine a user's interests are based on assumptions regarding the user's contextual searches and web surfing history. Ultimately, these assumptions about a user's actual interests may be entirely inaccurate, and an advertisement targeted to a user based on incorrect assumptions would be ineffective.

In the case of what is known as “brand advertising,” criteria other than context are often used. Traditionally, marketers have employed the use of psychographic or demographic information they have on an individual or of the audience in general. For example, Budweiser might choose to advertise in Maxim magazine if they want to reach Men in a specific age category.

However, all the systems and methods described above track a user's actions to implicitly determine what interests, brands, affiliations the user may have (oftentimes, by covertly observing the user's actions without the user's acknowledgement or assent). With the increasing popularity of dynamic advertising platforms such as the Internet and on mobile phones where a specific advertisement can be chosen to be displayed to a specific user, having user data which directly reflects the user's explicit interests has great value for advertisers and marketers. As such, it would be desirable to provide a system and method for a user to explicitly express her interests and affinities in order to more effectively select and target advertising to the given user.

### SUMMARY OF THE INVENTION

In accordance with a preferred embodiment of the present invention, a system for target advertising incorporates psychographic and demographic information, in addition to employing the use of a user's “Hotlist” data to decide which advertisement to display to a user. While the above described prior art systems try to implicitly determine from a user's actions what brands she might like, in accordance with a preferred embodiment of the invention, the system obtains that data by having an individual explicitly enter her brand affinities into the system. A user's “Hotlist” as described is a list, catalog or selection, which may include, but is not limited to any brand, product, interest, activity, affiliation, attraction, or entertainment source. In total, a Hotlist represents a user's profile of interests and provides a means of self-expression and identity.

A Hotlist enables a marketer to target advertisements more effectively based on the brands a user has explicitly announced an affinity for. For example, Gap Inc. may choose to show advertisements for their clothing and accessories to users who have added “Gap” to their Hotlist. Alternatively, competitors might want to advertise to users who have stated a preference for their competitor's brand. For example, Coors might want to advertise their products or promotions to users who have stated a preference for Budweiser in order gain market or mind share from their direct competitors.

In accordance with another preferred embodiment of the present invention, advertisement selection can also be done by virtue of performing mathematical correlations to model a user's interest. For instance, mathematically analyzing Hotlist data from multiple users, may reveal that women who have a stated preference for Gap, BMW, and Coca-Cola also tend to have a preference (whether explicitly stated or not) for McDonald's. Based on this correlation, the system might choose to advertise McDonald's to people who have stated a preference for Gap, BMW, and/or Coca-Cola.

Other and further features and advantages of the present invention will be apparent from the following descriptions of the various embodiments. It will be understood by one of ordinary skill in the art that the following embodiments are provided for illustrative and exemplary purposes only, and that numerous combinations of the elements of the various embodiments of the present invention are possible.

### DESCRIPTION OF THE DRAWINGS

FIG. 1 is a flowchart which illustrates the method of target advertising to a user based on a user-generated Hotlist in accordance with one embodiment of the present invention.

FIG. 2 is an exemplary screen shot of a user's management of a Hotlist in the “Clothing” category in accordance with one embodiment of the present invention.

FIG. 3 is an exemplary screenshot of a user-generated Hotlist item in accordance with one embodiment of the present invention.

FIG. 4 is an exemplary screen shot of a user's Hotlist in accordance with one embodiment of the present invention.

FIG. 5 is an exemplary screen shot of a user's profile and Hotlist in accordance with one embodiment of the present invention.

### DESCRIPTION OF THE INVENTION

Aspects of the present invention may be implemented at any site or application accessible via the Internet, where a user's profile information and/or explicit interests can be entered, viewed or managed, including but not limited to social networking sites (e.g. Facebook.com, MySpace.com, and HOTorNOT.com), virtual online communities, including gaming communities (e.g. HabboHotel.com, TalkCity.com, Second Life, and World of Warcraft), instant messaging software and chat rooms (e.g. AOL Instant Messenger and Windows Live Messenger), Internet service provider home pages (e.g. my.AOL.com and att.my.yahoo.com), webmail providers (e.g. Gmail.com by Google, Hotmail.com by Microsoft, and Yahoo! Mail), auction sites (e.g. eBay.com), forums, newsposts, and blogs.

Aspects of the present invention are typically implemented on one or more computers executing software instructions. According to one embodiment of the present invention, server and client computer systems transmit and receive data over a computer network or a fiber or copper-based telecommunications network. For example, the steps of generating a Hotlist and presenting a user with a targeted advertisement based on the Hotlist, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instruction over the network connection, it stores the instructions in memory. The server may store the instructions for later execution, or it may execute the instructions as they arrive over the network connection. In some cases, the CPU may directly support the downloaded instructions. In other cases, the instructions may not be directly executable by the CPU and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, or to any particular source for the instructions executed by the server or client computers. In some instances, client and server functionality may be implemented on a single computer platform.

The client and server computers may be implemented as desktop personal computers, workstation computers, mobile computers, portable computing devices, personal digital assistant (PDA) devices, cellular telephones, digital audio or video playback devices, or any other similar type of computing device. For purposes of the following description, the terms “network” and “online” may be used interchangeably and do not imply a particular network embodiment or topography. In general, any type of network (e.g., LAN, WAN, or Internet) may be used to implement the online or computer networked implementation of the target advertising system.

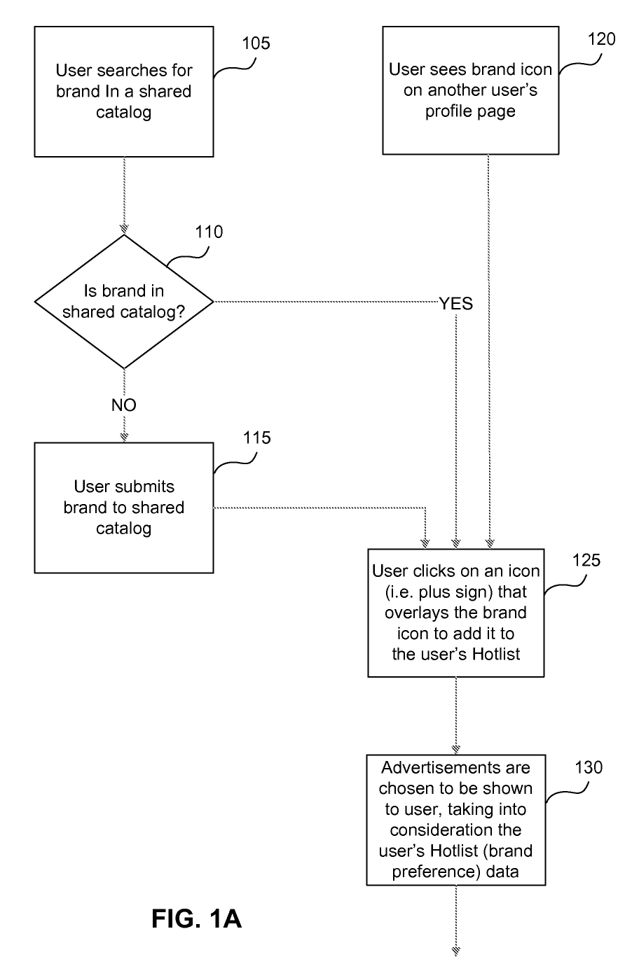

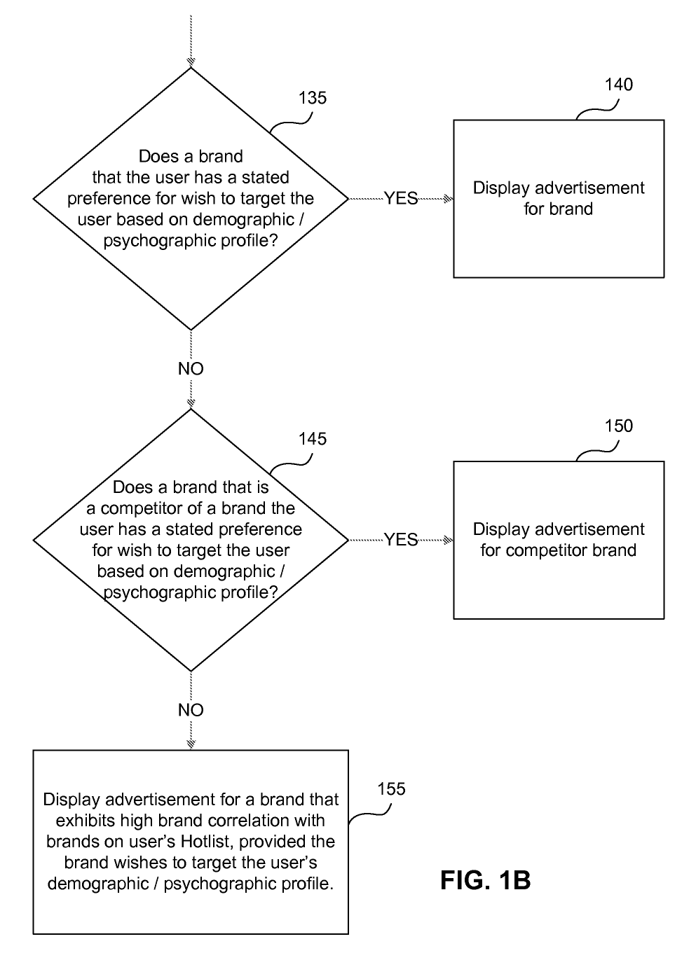

FIG. 1 is a flowchart which describes the method of target advertising to a user based on a user-generated Hotlist in accordance with one embodiment of the present invention. More specifically, FIG. 1A illustrates the process by which a user adds a brand to her Hotlist, and subsequently, is shown advertisements based on the contents of her Hotlist. FIG. 1B illustrates the process by which the user's Hotlist data is used to determine which advertisement to display to the user.

Referring to FIG. 1, the Hotlist is a list of brands compiled by a user to list brands that she feels an affinity for. Brands are often selected by a user based on the individual identifying with and feeling commonality with key attributes that they feel the brand stands for. For example, Apple's brand attributes might include “innovative” and “individualistic” (hence, their “Think Different” advertising campaign). Therefore, an individual who feels she is innovative and unique is more likely to feel an affinity for the Apple brand.

A Hotlist of a person's preferred brands therefore creates a picture, or more precisely, a mural, of how a person perceives herself, and, when viewed and analyzed in totality, can be used to select which advertisements will resonate most effectively with that person.

Acquiring and Presenting Hotlist data

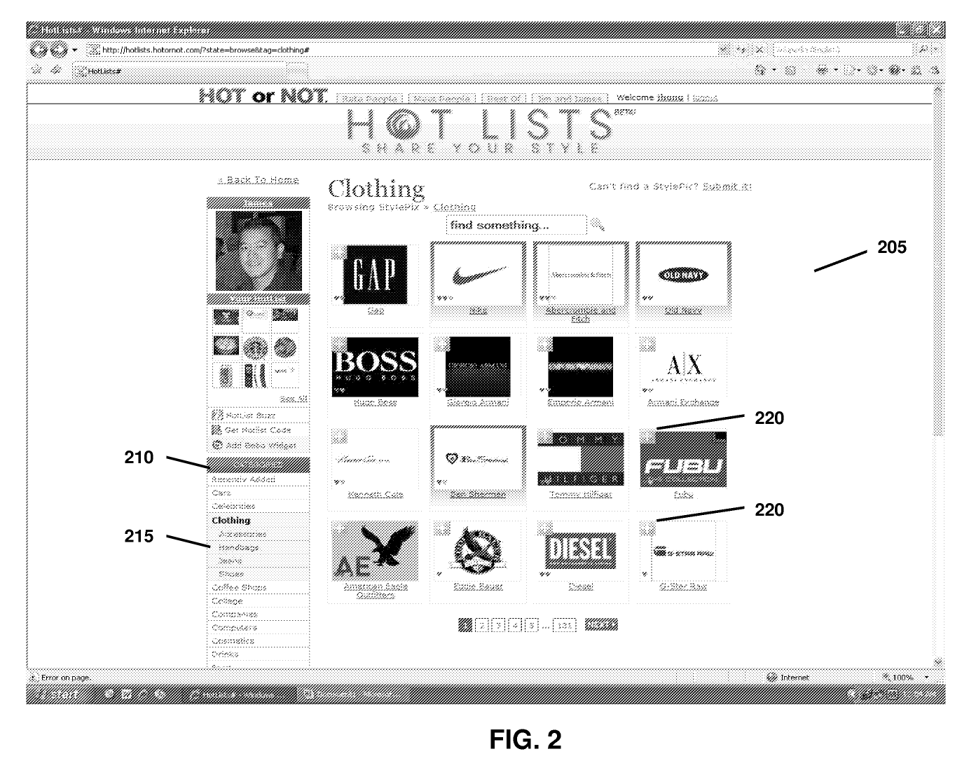

In FIG. 1A at block 105, a user searches for a brand in a shared catalog of brands. In accordance with one embodiment of the present invention, the brands can include products or services from any company or organization, and can be represented by any number of marks or logos for such brands, including user-generated marks, logos or icons. In accordance with one embodiment of the present invention, the aggregation and presentation of the Hotlist data may be handled by a “Hotlist engine.” The Hotlist engine operates to provide for and maintain the items in the shared catalog (e.g. Hotlist selection), to store, retrieve, present, and manage user profile data and Hotlists in a graphical interface, as shown in exemplary screenshots in FIGS. 2-5. Profile data includes data variables used to define a demographic profile and/or a psychographic profile. These profiles provide enough information about the typical member of a group to create a mental picture of a hypothetical aggregate. Several data variables which would make up a demographic profile, for example, may include a user's sex, marital status, economic class, and age range. In contrast, but as a complement to a demographic profile, a psychographic profile is composed of data variables including, but is not limited to, attributes relating to personality, values, attitudes, or lifestyles. Psychographics can be viewed as an equivalent of the concept of “culture.”

At decision block 110, if the brand is not in the shared catalog, the process proceeds to block 115. At block 115, the user submits the brand to the shared catalog. If the brand is not already in a shared catalog of brands for users to select from, the user can submit the brand name, a picture of a brand logo, and/or other information relating to and classifying the brand, thereby adding the brand to the shared catalog for that user and other users to add to their respective Hotlists. The process passes to block 125.

At decision block 110, if the brand that the user desires to add to her Hotlist is present in the shared catalog, the process proceeds to block 125.

In block 120, if a user sees a brand icon on another user's profile page and/or Hotlist and desires to add the brand to her Hotlist, the process also proceeds to block 125.

At block 125, a user can add the brand to her Hotlist by selecting the brand/brand icon. In accordance with one embodiment of the present invention, the user can click on a symbol (e.g. an “add brand” icon) that overlays the brand/brand icon to add to the user's Hotlist. In one embodiment of the present invention, users are able to add brands to their “Hotlist” by clicking on a plus sign (“+”) displayed on top of a logo of the brand they would like to add (e.g. symbol 220 in FIG. 2). By adding a brand to her Hotlist, a user is creating a list which can then be displayed on her online profile for others to see what kind of brands she likes. The present invention allows users to associate themselves with brands, and therefore, provides users a means of self expression to display which brands they prefer. While the primary motive of a user to create a Hotlist is, in fact, not for the benefit of targeting advertisements, but rather as a means of self expression, the user also provides marketing firms and advertisers with valuable information and direct feedback regarding brands for use in their advertisements and marketing campaigns. With at least one brand in a user's profile and/or Hotlist, control then passes to block 130.

In accordance with one embodiment of the present invention, a user of a social networking site may simply add a brand or interest by clicking on a text or symbol link, which in turn, may automatically notify others of the user's affinity for the brand or interest. For example, a text link for a brand may indicate “Add to Hotlist,” “Notify My Friends,” or “I'm a Fan,” which may in turn, automatically send a message, news feed or e-mail notifying other users with an embedded link to the Hotlist brand. The resulting message, news feed, or e-mail may read, for example, “Your friend, Max, is now a fan of In-N-Out Burgers. Click here if you're a fan too!” This embodiment allows users to express themselves and share their interests with other users. It also provides targeted advertising by enabling a brand to reach out to a user's friends and connections who likely share similar tastes and affinities.

At block 130, the acquired Hotlist data presented by users is aggregated and analyzed by computer systems such as an advertisement targeting engine to determine precisely which advertisements are most effectively targeted to a given user. Control then passes to decision block 135 (in FIG. 1B).

Use of Hotlist data by an Advertisement Targeting Engine

The data from a Hotlist helps to select which advertisements would be most effective to show a user. Based on an analysis of the aggregated profile and/or Hotlist data, a computer system in accordance with one embodiment of the present invention (i.e. an advertisement targeting engine) can provide an effective targeted advertisement in one of three ways.

At decision block 135, the Hotlist engine that aggregates the profile and Hotlist data provides data to the advertisement targeting engine to determine whether a brand that the user has a stated preference for (i.e. added to her Hotlist) desires to target the user based on the user's demographic and/or psychographic profile. If so, at block 140, an advertisement is displayed from an advertiser who is on the user's Hotlist and who has requested to have their advertisement shown to people in the user's demographic and/or psychographic profile. If not, control passes to decision block 145.

At decision block 145, the advertisement targeting engine determines whether a competitor of a brand the user has a stated preference for desires to target the user based on the user's demographic and/or psychographic profile. If so, at block 150, an advertisement is displayed from a competitor of a brand who is on the user's Hotlist and who has requested to have their advertisement shown to people in the user's demographic and/or psychographic profile. If not, control passes to block 155.

At block 155, an advertisement is displayed from an advertiser whose brand is automatically and mathematically computed to have high levels of correlation with other brands on the user's Hotlist, and who has requested to have their correlated brand targeted to the user based on the user's demographic and/or psychographic profile.

FIG. 2 is an exemplary screenshot of a user's management of a Hotlist in the “Clothing” category in accordance with one embodiment of the present invention. Catalog page 205 includes clothing brands and brand icons from a shared catalog of brands which a user can add individually to his Hotlist if he desires. The brands and brand icons include, for example, Gap, Nike, Abercrombie and Fitch, Giorgio Armani, and Fubu. These brands are categorized under “Clothing” in category listing 210. This classification of brands makes it easier for a user to search for and identify brands and brand icons. The categories may include, for example, “Cars,” “Celebrities,” “Computers,” “Food,” “Magazines, “Movies,” “Restaurants,” “Sports,” and “Travel.” The brands can be further classified into additional sub-categories 215. Under the “Clothing” category, additional categories can include, for example, accessories, handbags, jeans and shoes. If a user wishes to add a brand to his Hotlist, the “add” symbol 220, represented by a “+”, provides the user with a quick and accessible way to express his interest and affinity for the brand.

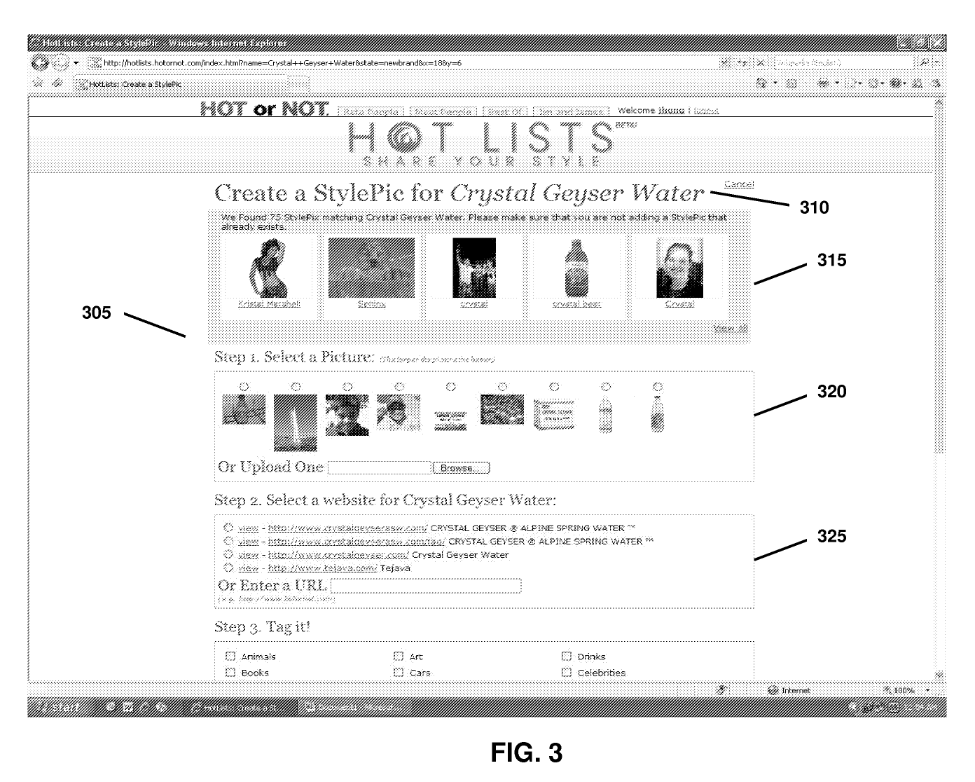

FIG. 3 is an exemplary screenshot of a user-generated Hotlist item in accordance with one embodiment of the present invention. Hotlist item creation page 305 provides a means for creating and submitting an item (i.e. brand, brand icon, interest, activity, etc.) into a shared catalog. A user first selects a context for the submission. Submission 310, in screenshot shown as FIG. 3, is “Crystal Geyser Water.” Frame 315 provides items from the shared catalog which best match the submission, “Crystal Geyser Water.” Frame 320 provides the user with the option of selecting an existing picture or icon in the shared catalog that best matches the submission, or in the alternative, provides the user the option of uploading a picture, icon, or other graphic to represent “Crystal Geyser Water.” Frame 325 provides the user with the option of selecting a website that best matches the submission, or entering a website associated with the Hotlist item.

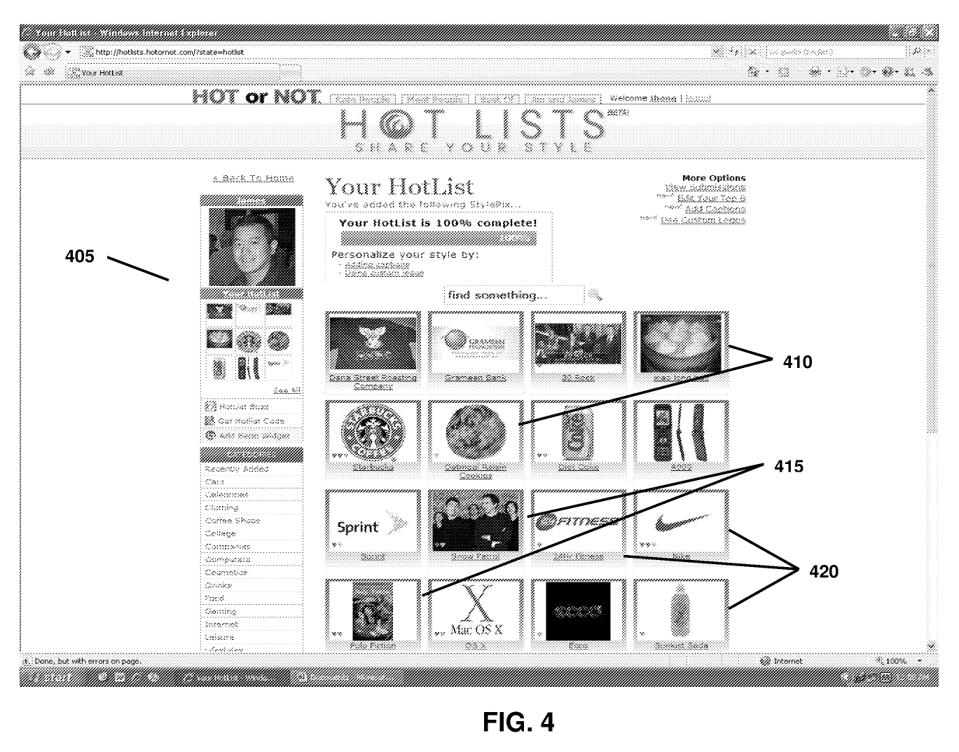

FIG. 4 is an exemplary screenshot of a user's Hotlist in accordance to one embodiment of the present invention. Hotlist page 405 illustrates, as an example, the diversity of Hotlist selections that represents a user's interests and affinities. Food items 410 are types of food, including “Oatmeal Raisin Cookies” and “Xiao Long Bao.” Entertainment items 415 represent the user's movie and music interests, including “Pulp Fiction” and the band “Snow Patrol.” Brand items 420 include products and services, including “Nike,” “24 Hr Fitness,” and “Sunkist Soda.”

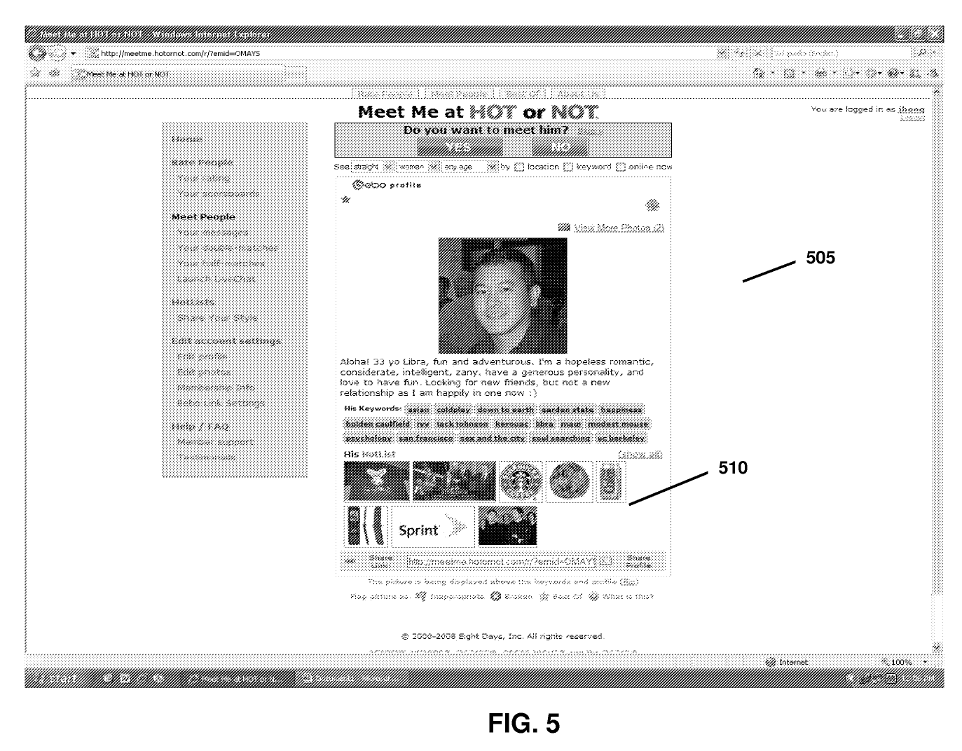

FIG. 5 is an exemplary screenshot of a user's profile and Hotlist in accordance with one embodiment of the present invention. Profile page 505 illustrates how a user, for example, may choose to have his Hotlist selections presented. The Hotlist items may be presented in various formats on his profile as shown by collage 510, where the Hotlist is presented as thumbnail icons for the various brands, pictures or graphics. As illustrated, the presentation may be a photo collage of the brands, or it may be an interactive experience such as an animation or game that involves the Hotlist data. These presentations provide the user with a variety of interesting and entertaining ways for him to present his interests and affinities, while additionally, sharing a taste of his identity to others and providing valuable marketing information to brands and advertisers.

The presentation of a user's Hotlist items may also be embedded on other websites that the Hotlist did not originate from. For example, as illustrated in the exemplary screenshots, in accordance with one embodiment of the present invention, a user's Hotlist can be created on HOTorNOT.com, but can be shared with additional groups of users when embedded into various other websites, including, but not limited to, MySpace.com and Facebook.com.

In accordance with another embodiment of the present invention, the user's Hotlist (either the selection in its entirety or a single item) may be presented to a user's friends list, contact list, or connections. This solicitation may be directed by the user or automatically generated by the computer system to share interests and affinities between one user and another. As is the model for embodiments of the present invention, this allows users to express themselves and share their interests with other users. But also as importantly, it provides targeted advertising by enabling a brand to reach out to a user's friends and connections who typically have similar affinities, with the same demographic and psychographic profiles. In accordance with yet another embodiment of the present invention, the advertisement targeting engine may also direct advertisements to a user based on the Hotlists of the user's friends and connections, who likely have the same tastes and share the same interests.

It should be noted that the location in which an advertisement is to be presented to a user does not need to be the same location as where the individual created her Hotlist. For instance, a user might create her Hotlist on HOTorNOT.com, but her Hotlist data might be used to determine and select advertisements that are to be shown to her on a different website, or, on a different medium including, but not limited to, a mobile phone, magazine, newspaper, television, movie, or radio.

As noted previously, the foregoing descriptions of the specific embodiments are presented for purposes of illustration and description. They are not intended to be exhaustive or to limit the invention to the precise forms disclosed, and obviously, many modifications and variations are possible in view of the above teachings. The embodiments were chosen and described in order to explain the principles of the invention and its practical applications, to thereby enable those skilled in the art to best utilize the invention and various embodiments thereof as suited to the particular use contemplated. It is intended that the scope of the invention be defined by the claims and their equivalents.

What is claimed is:

1. A computer-based method for targeting advertisement to users on a computer network, comprising:
generating a catalog with at least one item of interest to the user;
allowing the user to select from the catalog an item of interest;
enabling the user to place the item of interest into a list expressing the interests of the user;
determining from a selection of advertisements an advertisement best suited for the user; and
presenting to the user the advertisement best suited for the user.

2. The method of claim 1, wherein determining from a selection of advertisements an advertisement best suited for the user, further comprises:
determining whether an advertiser of a brand within the selection of advertisements is targeting the user based on the interest of the user in the brand.

3. The method of claim 1, wherein determining from a selection of advertisements an advertisement best suited for the user, further comprises:
determining whether an advertiser of a brand within the selection of advertisements is targeting the user based on the interest of the user in a competitor of the brand.

4. The method of claim 1, wherein determining from a selection of advertisements an advertisement best suited for the user, further comprises:
determining whether an advertiser of a brand within the selection of advertisements is targeting the user based on the interest of the user in other brands high correlated with the brand.

5. The method of claim 1, wherein determining from a selection of advertisements an advertisement best suited for the user is based on a list expressing the interests of another user.

6. The method of claim 1, wherein generating a catalog with at least one item of interest to the user, further comprises:
enabling the user to submit the at least one item of interest into the catalog.

7. The method of claim 1, further comprising:
enabling the user to input user profile information.

8. The method of claim 7, wherein an advertisement best suited for the user is one targeted to a demographic audience that corresponds with user profile information provided by the user.

9. The method of claim 1, wherein providing to the user the advertisement best suited for the user, further comprises:
provisioning the advertisement to at least one of the following mediums: mobile phones, magazines, newspapers, television, movies, and radio.

10. A method for targeting advertisement to members on a social networking community over a computer network, comprising:
generating a set of items of interest for selection by a member;
allowing the member to select at least one item of interest from the set of items;
enabling the member to place the at least one item of interest into a list associated with the member;
contacting a group of members affiliated with the member;
notifying the group of members that the member has the at least one item of interest in the list associated with the member; and
displaying an advertisement associated with the at least one item of interest to the group of members.

11. The method of claim 10, wherein the set of items includes brand name products and services.

12. The method of claim 9, further comprising:
providing the group of users access to view the list associated with the member.

13. The method of claim 10, wherein notifying the group of members that the member has the at least one item of interest in the list associated with the member, further comprises:
generating a request to each member of the group of members to place the at least one item of interest into a list associated with each member in the group of members.

14. The method of claim 10, wherein generating a set of items for selection by a member, further comprises:
enabling the member to generate at least one item for the set of items of interest.

15. The method of claim 14, further comprising:
incorporating the at least one item generated by the member into the set of items of interest for selection by all members of the social networking community.

16. A system for provided targeted advertising, comprising:
at least one server comprising:
a selection of advertisements;
a hotlist engine operative to retrieve and aggregate profile and interest data input by a user; and
an advertisement targeting engine operative to determine from the selection of advertisements an advertisement to present to the user based on the user's profile and interest data;
at least one client device comprising:
an input device to input the user's profile and interest data; and
a display to display the advertisement determined by the advertisement targeting engine; and,
a communication link providing communication between the at least one server and the at least one client device.

17. The system of claim 16, wherein the advertisement targeting engine determines whether an advertiser of a brand having an advertisement within the selection of advertisements is targeting the user based on the user's profile and interest data.

18. The system of claim 16, wherein the advertisement targeting engine presents an advertisement to the user based on profile and interest data input by other users known to the user.

19. The system of claim 16, wherein the hotlist engine is further operative to:
generate a catalog with at least one item of interest to the user;
allow the user to select from the catalog an item of interest; and
enable the user to place the item of interest into a hotlist expressing the interests of the user.

20. A computer program product for target advertising, the computer program product being embodied in a computer readable medium and comprising computer instructions which, when executed by a processor cause a computer to:
provide a catalog with at least one brand to the user;
allow the user to select from the catalog a brand;
enable the user to place the brand into a list of the user's selected brands;
determine from a selection of advertisements an advertisement for the user based on the interests of the user; and
display the advertisement to the user.
